(19) United States
(12) Patent Application Publication
(10) Pub. No.: US 2008/0241600 A1
(43) Pub. Date: Oct. 2, 2008

(54) MAGNETIC RECORDING MEDIUM AND PROCESS FOR PRODUCING THE SAME

(75) Inventors: Hiroyuki Tanaka, Tokyo (JP); Tsutomu Ide, Tokyo (JP); Osamu Inoue, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK Corporation, Tokyo (JP)

(21) Appl. No.: 12/056,568

(22) Filed: Mar. 27, 2008

(30) Foreign Application Priority Data
Mar. 30, 2007 (JP) 2007-094976

(51) Int. Cl. G11B 5/66; B05D 5/12

(52) U.S. Cl. 428/832; 427/131

(57) ABSTRACT

The present invention provides a magnetic recording medium wherein a fine non-magnetic inorganic powder, the dispersibility of which is improved, is used to improve the surface smoothness of a lower non-magnetic layer, thereby giving an excellent surface smoothness of an upper magnetic layer and electromagnetic conversion property; and a production process thereof. A magnetic recording medium comprising at least a non-magnetic support, a lower non-magnetic layer on one surface of the non-magnetic support, and an upper magnetic layer on the lower non-magnetic layer, wherein the upper magnetic layer contains at least a ferromagnetic powder, and a binder resin material, and the lower non-magnetic layer contains at least carbon black, iron oxide, and a binder resin material, and the iron oxide has an average major axis length of 30 to 100 nm, and a specific surface area based on the BET method of 80 to 120 m²/g, and the iron oxide contains moisture in an amount per unit specific surface area of 0.13 to 0.25 mg/m².

### BACKGROUND OF THE INVENTION

1. Field of the Invention

The present invention relates to a magnetic recording medium, and a process for producing the same, more specifically, a magnetic recording medium excellent in surface smoothness of its magnetic layer and electromagnetic conversion property, and a process for producing the same.

2. Disclosure of the Related Art

In recent years, the recording density of magnetic recording media has been desired to be made high in order to cope with an increase in the quantity of recording data. In particular, as for magnetic tapes used to record data into a computer, which are called LTO (registered trademark: Linear Tape Open), DLT (registered trademark: Digital Linear Tape) and other magnetic recording media, the recording density thereof has been desired to be made high. In order to make the recording density high, the recording wavelength is made shorter and the magnetic layer is made thinner. As the recording wavelength is made shorter, the magnetic layer surface is required to be made smoother from the viewpoint of spacing loss.

When the magnetic layer is made thin, the surface roughness of a support is reflected on the magnetic layer surface, so that the smoothness of the magnetic layer surface is damaged. Thus, the electromagnetic conversion property deteriorates. For this reason, a non-magnetic layer is formed as an undercoat layer on the surface of the support, and then the magnetic layer is formed on this non-magnetic layer. Accordingly, the non-magnetic layer surface is also required to be smoother.

Japanese Laid-Open Patent Publication No. Hei 9-170003 (1997) discloses a magnetic recording medium having a lower non-magnetic layer using an acicular hematite particle powder in which the average major axis diameter is 0.3 μm or less, the geometrical standard deviation value of the major axis diameter distribution of the particles is 1.50 or less, the BET specific surface area value is 35 m²/g or more, the powdery pH value is 8 or more, the content of soluble sodium salts, which is converted to the Na content, is 300 ppm or less, and the content of soluble sulfates, which is converted to the SO₄ content, is 150 ppm or less (claims 1 and 4).

Japanese Laid-Open Patent Publication No. 2004-5932 discloses a magnetic recording medium having a lower non-magnetic layer using a powder made of flat acicular iron oxide particles, in which: the average major axis length is from 20 to 200 nm; a minor axis section obtained by cutting any one of the particles in a direction perpendicular to the major axis has a long width and a short width; the minor axis sectional area ratio between the long width and the short width is larger than 1.3 substantially uniformly in the major axis direction; and the specific surface area based on the BET method is from 30 to 100 m²/g (claims 1 and 4).

Japanese Laid-Open Patent Publication No. 2005-149623 discloses a magnetic recording medium having a lower non-magnetic layer using a non-magnetic inorganic powder having an average particle diameter of 80 nm or less (claim 1).

### SUMMARY OF THE INVENTION

According to Japanese Laid-Open Patent Publication No. 2005-149623, a lower non-magnetic layer having a good surface smoothness is obtained by using a non-magnetic inorganic powder having an average particle diameter of 80 nm or less as a non-magnetic layer coating component and treating the powder under optimal dispersing conditions. As a result, a good surface smoothness of an upper magnetic layer is realized. When the non-magnetic inorganic powder is made finer, the specific area increases. For this reason, if the powder is not treated under appropriate dispersing conditions when the non-magnetic layer coating material is prepared, the fine particles aggregate or the viscosity of the coating material increases. In short, the stability of the non-magnetic layer coating material deteriorates over time. If the non-magnetic layer coating material poor in stability over time is used, a good surface smoothness of the lower non-magnetic layer is not easily obtained, so that a good surface smoothness of the upper magnetic layer is not realized (Comparative Example 4 in the publication).

An object of the present invention is to provide a magnetic recording medium wherein a fine non-magnetic inorganic powder, the dispersibility of which is improved, is used to improve the surface smoothness of a lower non-magnetic layer, thereby giving an excellent surface smoothness of an upper magnetic layer and an excellent electromagnetic conversion property; and a production process thereof.

The present inventors have found out that when a fine non-magnetic inorganic powder for a lower non-magnetic layer contains moisture (or water) in an amount per unit specific surface area within a specified range, the dispersibility is improved to improve the stability of a non-magnetic layer coating material.

The present invention comprises the followings:

(1) A magnetic recording medium comprising at least a non-magnetic support, a lower non-magnetic layer on one surface of the non-magnetic support, and an upper magnetic layer on the lower non-magnetic layer,

wherein the upper magnetic layer contains at least a ferromagnetic powder, and a binder resin material, and

the lower non-magnetic layer contains at least carbon black, iron oxide, and a binder resin material, and the iron oxide has an average major axis length of 30 to 100 nm, and a specific surface area based on the BET method of 80 to 120 m²/g, and the iron oxide contains moisture in an amount per unit specific surface area of 0.13 to 0.25 mg/m².

(2) The magnetic recording medium according to above-described (1), wherein the binder resin material contained in the lower non-magnetic layer is a cured product of an electron beam curable resin.

(3) The magnetic recording medium according to above-described (1) or (2), wherein the binder resin material contained in the lower non-magnetic layer contains a polar group.

(4) The magnetic recording medium according to any one of above-described (1) to (3), wherein the lower non-magnetic layer has a thickness of 0.3 μm or more and 2.5 μm or less.

(5) The magnetic recording medium according to any one of above-described (1) to (4), wherein the upper magnetic layer has a thickness of 0.30 μm or less.

(6) The magnetic recording medium according to any one of above-described (1) to (5), which has, on the other surface of the non-magnetic support, a back coat layer containing at least carbon black, a non-magnetic inorganic powder other than carbon black, and a binder resin material.

(7) The magnetic recording medium according to any one of above-described (1) to (6), which is used in a magnetic recording/reproducing system wherein reproduction is attained by means of a magneto resistive head (MR head).

(8) A process for producing a magnetic recording medium comprising at least a non-magnetic support, a lower non-magnetic layer on one surface of the non-magnetic support, and an upper magnetic layer on the lower non-magnetic layer, the process comprising the steps of:

applying, onto one surface of a non-magnetic support, a coating material for a non-magnetic layer which contains at least carbon black, iron oxide, and a binder resin material, wherein the iron oxide has an average major axis length of 30 to 100 nm, and a specific surface area based on the BET method of 80 to 120 m²/g, and the iron oxide contains moisture in an amount per unit specific surface area of 0.13 to 0.25 mg/m², and drying and curing the resultant, thereby forming a lower non-magnetic layer; and

applying, onto the lower non-magnetic layer, a coating material for a magnetic layer which contains at least a ferromagnetic powder, and a binder resin material, and drying the resultant, thereby forming an upper magnetic layer.

According to the present invention, in the lower non-magnetic layer, the following iron oxide is used as a non-magnetic inorganic powder: iron oxide which has an average major axis length of 30 to 100 nm, and a specific surface area of 80 to 120 m²/g, the area being based on the BET method, and which contains moisture in an amount per unit specific surface area of 0.13 to 0.25 mg/m². Iron oxide having moisture content (or water content) within such a specified range exhibits a good dispersibility in a non-magnetic layer coating material although the iron oxide is a fine powder having an average major axis length of 30 to 100 nm, and a specific surface area based on the BET method of 80 to 120 m²/g. As a result, this prepared non-magnetic layer coating material is a non-magnetic layer coating material excellent in stability, wherein the powder is uniformly dispersed. For this reason, in the lower non-magnetic layer, a good surface smoothness is obtained, thereby realizing a good surface smoothness of an upper magnetic layer. As a result, a magnetic recording medium excellent in electromagnetic conversion property is obtained.

### DETAILED DESCRIPTION OF THE INVENTION

The magnetic recording medium of the present invention comprises at least a non-magnetic support, a lower non-magnetic layer on one surface of the non-magnetic support, and an upper magnetic layer on the lower non-magnetic layer, and commonly comprises a back coat layer on the other surface of the non-magnetic support. The lower non-magnetic layer has a thickness of, for example, 0.3 to 2.5 μm, the upper magnetic layer has a thickness of, for example, 0.30 μm or less, preferably 0.03 to 0.30 μm, and the back coat layer has a thickness of, for example, 0.3 to 0.8 μm. The total thickness of the magnetic recording medium is preferably from 4.0 to 10.0 μm. A lubricant coating layer, various coating layers for protecting the magnetic layer, and the like may be formed on the upper magnetic layer if necessary. An undercoat layer (adhesive layer) may be formed on the one surface of the non-magnetic support on which the magnetic layer is to be formed, in order to attain an improvement in the adhesive property between the lower non-magnetic layer and the non-magnetic support, and other effects. In this case, the thickness of the undercoat layer is preferably from 0.05 to 0.30 μm. In order that the adhesive property improvement and the other effects can be expressed, the thickness of the undercoat layer is preferably 0.05 μm or more. When the thickness is 0.05 μm or more and 0.30 μm or less, these effects become sufficient.

### [Lower Non-Magnetic Layer]

The lower non-magnetic layer contains at least carbon black, iron oxide as a non-magnetic inorganic powder, and a binder resin material.

The carbon black contained in the lower non-magnetic layer may be furnace black for rubber, thermal black for rubber, black for color, acetylene black or the like. It is preferred that the specific surface area thereof is from 5 to 600 m²/g, the DBP oil absorption thereof is from 30 to 400 mL/100 g, and the particle diameter thereof is from 10 to 100 nm. For the carbon black which can be used, specifically, “carbon black guide book” edited by the Carbon Black Association of Japan can be referred to.

The amount of the carbon black incorporated into the lower non-magnetic layer is from 5 to 30% by mass, preferably from 10 to 25% by mass of the lower non-magnetic layer.

The iron oxide contained in the lower non-magnetic layer is acicular α-Fe₂O₃ which has an average major axis length of 30 to 100 nm, a specific surface area based on the BET method of 80 to 120 m²/g, and which contains moisture in an amount per unit specific surface area of 0.13 to 0.25 mg/m². From the viewpoint of the running durability of the magnetic recording medium, it is important to use the iron oxide as a non-magnetic inorganic powder contained in the lower non-magnetic layer.

If the average major axis length of the iron oxide is more than 100 nm, the dispersibility in a non-magnetic layer coating material becomes good; however, the smoothness of the non-magnetic layer surface lowers. On the other hand, if the average major axis length is less than 30 nm, the powder is too fine so that the dispersibility is poor and the stability of the non-magnetic layer coating material deteriorates. Thus, a uniform coated film is not easily formed. The smoothness of the non-magnetic layer surface lowers as well. As iron oxide is made finer, the specific surface area based on the BET method generally becomes larger. In the present invention, however, the specific surface area of the iron oxide based on the BET method ranges from 80 to 120 m²/g. In the case of the iron oxide having an average major axis length of 30 nm, the specific surface area thereof based on the BET method is appropriately about 120 m²/g. If the area is more than 120 m²/g, the powder turns into such a form that a great number of irregularities are present in the powder surface, so that the dispersibility deteriorates in the coating material. On the other hand, in the case of the iron oxide having an average major axis length of 100 nm, the specific surface area thereof based on the BET method is appropriately about 80 m²/g. If the area is less than 80 m²/g, the powder easily aggregates. Thus, the dispersibility in the coating material deteriorates as well.

The average major axis length of the iron oxide ranges preferably from 30 to 70 nm, more preferably from 30 to 50 nm. The specific surface are of the iron oxide based on the BET method ranges preferably from 80 to 100 m²/g.

In the case of the fine iron oxide powder, which has an average major axis length of 30 to 100 nm and a specific surface area, based on the BET method, of 80 to 120 m²/g, as it is, a good dispersibility is not obtained. The present inventors have investigated to find out that by incorporating moisture in an amount per unit specific surface area of 0.13 to 0.25 mg/m² into the iron oxide powder, the iron oxide powder exhibits a good dispersibility although the powder is a fine iron oxide powder. It appears that by setting the amount of moisture into the specified range, interaction is generated between moisture present in the iron oxide powder surface and polar groups present in the binder resin in the non-magnetic layer coating material so that the so-called wettability is improved to give a good dispersibility to the iron oxide powder. The dispersibility of the iron oxide powder is improved so that the iron oxide powder does not aggregate. For this reason, the produced non-magnetic layer coating material is a non-magnetic layer coating material excellent in stability, wherein the powder is uniformly dispersed. This non-magnetic layer coating material is used to form a uniform non-magnetic layer excellent in surface smoothness. The above-mentioned wettability-improving effect is produced not only in the non-magnetic layer coating material but also in the formed non-magnetic layer; therefore, in the non-magnetic layer of the magnetic recording medium also, the good dispersibility of the iron oxide powder is maintained. As a result of these effects, a good surface smoothness of an upper magnetic layer can be realized so that a magnetic recording medium excellent in electromagnetic conversion property is obtained.

If the amount of moisture per unit specific surface area in the iron oxide powder is less than 0.13 mg/m², the amount of moisture is small so that the wettability-improving effect is not obtained. Thus, a good dispersibility of the fine iron oxide powder is not obtained. On the other hand, if the above-mentioned amount of moisture is more than 0.25 mg/m², the amount of moisture is too large so that the solubility of the binder resin in an organic solvent is restrained. Thus, a good dispersibility of the fine iron oxide powder is not obtained. The amount of moisture per unit specific surface area in the iron oxide powder is preferably from 0.17 to 0.25 mg/m². The amount of moisture in the iron oxide powder can be controlled by, for example, the concentration of water vapor when the iron oxide powder is retained in nitrogen gas flow containing the water vapor in the preparation of the iron oxide.

An outline of the preparation of the iron oxide powder used in the present invention will be described hereinafter. An acicular Iron oxide, α-Fe₂O₃, is generated by subjecting an acicular iron hydroxide oxide, α-FeOOH, to dehydrating treatment at high temperature.

### (Step of Producing Iron Hydroxide Oxide)

As for the production of iron hydroxide oxide, for example, to an aqueous solution of a ferric salt is added an aqueous solution of an alkali hydroxide in an amount of 1.0 to 3.5 equivalents relative to the amount of Fe at a solution temperature of 10 to 90° C. while the former solution is stirred. In this way, a suspension containing a precipitation of ferric hydroxide is yielded. Thereafter, the suspension containing the precipitation of ferric hydroxide is matured for 2 to 20 hours while the temperature thereof is maintained at a temperature of 30 to 50° C., and then the precipitation is hydrolyzed. In this way, iron hydroxide oxide is produced.

As described above, it is advisable to maintain the suspension containing the precipitation of ferric hydroxide at a temperature of 30 to 50° C. If this maintenance temperature is made low, the average major axis length of iron hydroxide oxide tends to become short. If the maintenance temperature is made high, the average major axis length of iron hydroxide oxide tends to become long. If the maintenance time (maturing time) is made short, the average major axis length of the iron hydroxide oxide tends to become short. If the maintenance time is made long, the average major axis length of iron hydroxide oxide tends to become long.

### (Step of Deposition Treatment of Phosphorus and Yttrium)

While the suspension containing the precipitation of iron hydroxide oxide is stirred, thereto is added an aqueous solution of a phosphorus compound, for example, an aqueous solution of phosphoric acid so as to set the amount of P to an amount of 0.1 to 5.0% by weight of iron hydroxide oxide. Thereafter, while the suspension is stirred, thereto is added an aqueous solution of yttrium so as to set the percentage by atom of Y to Fe (Y/Fe) in the iron hydroxide oxide into the range of 0.1 to 10% by atom. The pH is set to 9 or less, so as to deposit phosphorus and yttrium on iron hydroxide oxide.

By performing the step of the deposition treatment of phosphorus and yttrium, the particles can be restrained from being sintered in calcination of the next step. As the amount of deposited yttrium becomes larger, the BET method specific surface area of the resultant iron oxide becomes larger.

### (Step of Calcination)

The suspension of the iron hydroxide oxide, on which phosphorus and yttrium are deposited (or adhered), is filtrated, and the residue is washed with water and dried. Thereafter, the powder of the iron hydroxide oxide is subjected to calcination treatment at 300 to 900° C., preferably 400 to 700° C. in the atmosphere for 10 to 60 minutes to change the iron hydroxide oxide to iron oxide. If the calcination temperature is too high, the particles are sintered. Thus, attention should be paid to the temperature. When the calcination is an appropriate calcination, iron oxide wherein the average major axis length of the iron hydroxide oxide is kept is obtained.

### (Step of Controlling the Amount of Moisture)

The resultant iron oxide powder is kept in nitrogen gas flow, 30 to 60° C. in temperature, containing 0.1 to 2.0% by volume of water vapor for 1 to 120 minutes to prepare an iron oxide powder having a desired amount of moisture per unit specific surface area. As the amount of water vapor contained in the nitrogen gas flow is larger or the keeping time is longer, the amount of moisture in the iron oxide powder becomes larger.

The blend amount of the iron oxide is from 50 to 80% by mass of the lower non-magnetic layer, preferably from 50 to 70% by mass thereof.

The lower non-magnetic layer may contain a non-magnetic inorganic powder other than carbon black and the iron oxide, for example, an inorganic powder of α-iron hydroxide oxide (α-FeOOH), CaCO₃, titanium oxide, barium sulfate, α-Al₂O₃, or the like. The form of α-iron hydroxide oxide is preferably an acicular form.

The blend ratio by mass of carbon black to the non-magnetic inorganic powder (total of the iron oxide and the non-magnetic inorganic powder other than the iron oxide) other than carbon black (carbon black/the non-magnetic inorganic powder other than carbon black (mass ratio)) is preferably from 95/5 to 5/95. If the ratio of blended carbon black is less than 5 parts by mass, a problem about surface electrical resistance may be caused. If the ratio of the blended non-magnetic inorganic powder other than carbon black is less than 5 parts by mass, the surface smoothness of the lower non-magnetic layer may deteriorate and the mechanical strength thereof may lower. The deterioration in the surface smoothness of the lower non-magnetic layer causes deterioration in the surface smoothness of the upper magnetic layer.

The binder resin material of the lower non-magnetic layer may be a combination that is appropriately selected from thermoplastic resins, thermosetting or thermoreactive resins, radiation (electron beam or ultraviolet ray) curable resins and other resins in accordance with the property of the medium or conditions for the production process thereof. Of these resins, electron beam curable resins are preferred. More preferred is a combination of electron beam curable vinyl chloride copolymer and polyurethane resin described below.

The vinyl chloride copolymer is preferably one having a vinyl chloride content of 50 to 95% by mass, and is more preferably one having a vinyl chloride content of 55 to 90% by mass. The average degree of polymerization thereof is preferably from about 100 to 500. Particularly, preferable is a copolymer made from vinyl chloride and a monomer having an epoxy(glycidyl) group. The vinyl chloride copolymer is modified to be electron beam sensitive by introducing (meth)acrylic double bonds, or the like, using known techniques.

The polyurethane resin, which is used together with the vinyl chloride resin, is a generic name given to resins obtained by reaction of hydroxy group containing resins, such as polyester polyol and/or polyether polyol, with polyisocyanate-containing compounds. The number-average molecular weight thereof is from about 5,000 to 200,000, and the Q value (i.e., the mass-average molecular weight/the number-average molecular weight) thereof is from about 1.5 to 4. The polyurethane resin is modified to be electron beam sensitive by introducing (meth)acrylic double bonds using known techniques.

In the present invention, the electron beam curable resin preferably contains a polar group in order to improve the dispersibility of the iron oxide. Examples of the polar group include S-containing polar groups such as —OSO₃M, —SO₃M and —SR, P-containing polar groups such as —POM, —PO₂M and —PO₃M, and —COOM wherein M represents hydrogen or an alkali metal; and —NR₂, —N⁺R₃X⁻ (wherein R represents hydrogen or a hydrocarbon group and X represents a halogen atom), phosphobetaine, sulfobetaine, phosphamine, sulphamine, and the like.

Besides the vinyl chloride copolymer and the polyurethane resin, known various resins may be incorporated into the non-magnetic layer at an amount in the range of 20% or less by mass of all the binders in this layer.

The content of the binder resin used in the lower non-magnetic layer is preferably from 10 to 100 parts by mass, more preferably from 12 to 30 parts by mass with respect to 100 parts by mass of the total of the carbon black and the non-magnetic inorganic powder other than the carbon black in the lower non-magnetic layer. If the content of the binder is too small, the ratio of the binder resin in the lower non-magnetic layer lowers so that a sufficient coating film strength cannot be obtained. If the content of the binder is too large, the medium, when being made into a tape, is easily warped along the width direction of the tape. Consequently, the state of contact between the tape and a head tends to get bad.

It is preferred that the lower non-magnetic layer comprises a lubricant if necessary. The lubricant may be saturated or unsaturated, and may be a known lubricant, examples of which include fatty acids such as stearic acid and myristic acid; fatty acid esters such as butyl stearate and butyl palmitate; and sugars. These may be used alone or in a mixture of two or more thereof. It is preferred to use a mixture of two or more fatty acids having different melting points, or a mixture of two or more fatty acid esters having different melting points. This is because it is necessary to supply lubricants adapted to all temperature environments in which the magnetic recording medium is used onto the surface of the medium without interruption.

The lubricant content in the lower non-magnetic layer may be appropriately adjusted in accordance with purpose, and is preferably from 1 to 20% by mass of the total mass of the carbon black and the non-magnetic inorganic powder other than the carbon black in the lower non-magnetic layer.

A coating material for forming the lower non-magnetic layer is prepared by adding an organic solvent to the above-mentioned individual components and subjecting the resultant to mixing, stirring, kneading, dispersing and other treatments in a known manner. The used organic solvent is not limited to any especial kind, and may be appropriately selected from various solvents such as ketone solvents (such as methyl ethyl ketone (MEK), methyl isobutyl ketone, and cyclohexane) and aromatic solvents (such as toluene). These may be used alone or in combination of two or more thereof. The amount of the added organic solvent is set into the range of about 100 to 900 parts by mass with respect to 100 parts by mass of the total of the carbon black, the various inorganic powder(s) other than the carbon black, and the binder resin.

In the present invention, the specific iron oxide powder is used; therefore, when the coating material is prepared, the iron oxide powder does not aggregate so that the viscosity of the coating material does not increase, either. Thus, the prepared non-magnetic layer coating material is a coating material excellent in stability, wherein the powder is uniformly dispersed.

The thickness of the lower non-magnetic layer is usually from 0.3 to 2.5 μm, preferably from 0.5 to 2.0 μm. If the non-magnetic layer is too thin, the layer is easily affected by the surface roughness of the non-magnetic support so that the surface smoothness of the non-magnetic layer deteriorates and, also, the surface smoothness of the magnetic layer deteriorates easily. Consequently, the electromagnetic conversion property of the magnetic layer tends to deteriorate. Also, too thin a non-magnetic layer leads to an increased light transmittance, causing problems when medium end is detected by the changes in the light transmittance. On the other hand, making a non-magnetic layer thicker than a certain thickness would not correspondingly improve the performance of the magnetic recording medium.

### [Upper Magnetic Layer]

The upper magnetic layer comprises at least a ferromagnetic powder and binder resin materials.

In the present invention, the ferromagnetic powder is preferably a magnetic metal powder or a planar hexagonal fine powder. The magnetic metal powder preferably has a coercive force Hc of 118.5 to 278.5 kA/m (1,500 to 3,500 Oe), a saturation magnetization σs of 70 to 160 Am²/kg (emu/g), an average major axis length of 0.02 to 0.1 μm, an average minor axis length of 5 to 20 nm, and an aspect ratio of 1.2 to 20. The Hc of the medium produced by use of the magnetic metal powder is preferably from 118.5 to 278.5 kA/m (1,500 to 3,500 Oe). The planar hexagonal fine powder preferably has a coercive force Hc of 79.6 to 278.5 kA/m (1,000 to 3,500 Oe), a saturation magnetization σs of 40 to 70 Am²/kg (emu/g), an average planar particle size of 15 to 80 nm, and a plate ratio of 2 to 7. The Hc of the medium produced by use of the planar hexagonal fine powder is preferably from 94.8 to 318.3 kA/m (1,200 to 4,000 Oe).

It is advisable that the magnetic layer comprises the ferromagnetic powder in an amount of about 70 to 90% by mass of the layer. If the content of the ferromagnetic powder is too large, the content of the binder decreases so that the surface smoothness deteriorates easily by calendering. On the other hand, if the content of the ferromagnetic powder is too small, a high reproducing output cannot be obtained.

The binder resin material for the upper magnetic layer is not particularly limited, and the following may be used: a combination that is appropriately selected from thermoplastic resins, thermosetting or thermoreactive resins, radiation (electron beam or ultraviolet ray) curable resins and other resins in accordance with the property of the medium or conditions for the production process thereof.

The content of the binder resin used in the upper magnetic layer is preferably from 5 to 40 parts by mass, more preferably from 10 to 30 parts by mass with respect to 100 parts by mass of the ferromagnetic powder. If the content of the binder is too small, the strength of the magnetic layer lowers so that the running durability of the medium deteriorates easily. On the other hand, if the content of the binder is too large, the content of the ferromagnetic powder lowers so that the electromagnetic conversion property tends to deteriorate.

The upper magnetic layer further contains an abrasive having a Mohs hardness of 6 or more, such as α-alumina (Mohs hardness: 9), for the purposes of increasing the mechanical strength of the magnetic layer and preventing clogging of the magnetic head. Such an abrasive usually has an indeterminate form, causes the magnetic head to be prevented from clogging, and causes the strength of the coating film to be improved.

The average particle size of the abrasive is, for example, from 0.01 to 0.2 μm, preferably from 0.05 to 0.2 μm. If the average particle diameter of the abrasive is too large, then the projections from the surface of the magnetic layer become significant, causing a decrease in the electromagnetic conversion property, an increase in the drop-outs, an increase in the head wear, and the like. If the average particle diameter of the abrasive is too small, then the projections from the surface of the magnetic layer will become small, leading to insufficient prevention of clogged heads.

The average particle diameter is usually measured with a transmission electron microscope. The content of the abrasive may be from 3 to 25 parts by mass, preferably from 5 to 20 parts by mass with respect to 100 parts by mass of the ferromagnetic powder.

If necessary, various additives may be added to the magnetic layer, examples of the additives including dispersants such as a surfactant, and lubricants such as higher fatty acid, fatty acid ester, and silicone oil.

A coating material for forming the upper magnetic layer is prepared by adding an organic solvent to the above-mentioned individual components and subjecting the resultant to mixing, stirring, kneading, dispersing and other treatments in a known manner. The organic solvent to be used is not limited to any especial kind, and may be the same as used in the lower non-magnetic layer.

The thickness of the upper magnetic layer is preferably from 0.03 to 0.30 μm, more preferably from 0.05 to 0.25 μm. If the magnetic layer is too thick, the self-demagnetization loss or thickness loss thereof increases.

The centerline average roughness (Ra) of the upper magnetic layer surface is preferably from 1.0 to 5.0 nm, more preferably from 1.0 to 4.0 nm. If the Ra is less than 1.0 nm, the surface is too smooth so that the running stability deteriorates. As a result, troubles are easily caused during running of the recording medium. On the other hand, if the Ra is more than 5.0 nm, the magnetic layer surface gets rough. As a result, the electromagnetic conversion properties of the magnetic recording medium, such as the reproducing output thereof, deteriorate in a reproducing system using an MR head.

### [Back Coat Layer]

A back coat layer is optionally provided in order to improve the running stability, and prevent the electrification of the magnetic layer or others. The structure and the composition thereof are not particularly limited. It is allowable to use, for example, a back coat layer containing carbon black, a non-magnetic inorganic powder other than carbon black, and a binder resin.

The back coat layer preferably contains carbon black in an amount of 30 to 80% by weight of the back coat layer as a standard.

The back coat layer may contain various non-magnetic inorganic powders other than the carbon black in order to control the mechanical strength. Examples of the inorganic powders include α-Fe₂O₃, CaCO₃, titanium oxide, barium sulfate, α-Al₂O₃, and the like.

A coating material for a back coat layer is prepared by adding an organic solvent to the individual components, and subjecting the resultant to mixing, stirring, kneading, dispersing and/or some other treatment(s) in known manners. The used organic solvent is not particularly limited, and may be the same as used in the upper magnetic layer coating material or the lower non-magnetic layer coating material.

The thickness of the back coat layer (after the layer is calendered) is 1.0 μm or less, preferably from 0.1 to 1.0 μm, more preferably from 0.2 to 0.8 μm.

### [Non-Magnetic Support]

The material used for the non-magnetic support is not particularly limited, and may be selected from various flexible materials, and various rigid materials in accordance with the purpose. The support should be made into a predetermined shape, such as a tape shape, sheet shape, card shape, and disk shape, and a predetermined size, in accordance with one out of various standards. Examples of the flexible materials include polyesters such as polyethylene terephthalate (PET) and polyethylene naphthalate (PEN), polyolefins such as polypropylene, and various resins such as polyamide (PA), polyimide (PI), polyamideimide (PAI), and polycarbonate. The non-magnetic support is preferably a film made of a resin selected from PEN, PA, PI, and PAI. The thickness of the non-magnetic support is, for example, 3.0 to 15.0 μm, and preferably from 2.0 to 6.0 μm.

### [Production of Magnetic Recording Medium]

In the present invention, prepared coating materials for forming the non-magnetic layer, for forming the magnetic layer, and for forming the back coat layer are used and subjected to applying, drying, calendering, curing and other treatments so as to form respective coating films (coating layers). In this way, a magnetic recording medium is produced.

In the present invention, it is preferred that the lower non-magnetic layer and the upper magnetic layer are formed in the so-called wet-on-dry coating manner. However, the layers may be formed in the wet-on-wet coating manner. In the case of the wet-on-dry coating manner, a coating material for the non-magnetic layer is first applied onto one surface of a non-magnetic support, and dried, and optionally the resultant is subjected to calendaring treatment, so as to yield an uncured lower non-magnetic layer. Thereafter, the uncured lower non-magnetic layer is cured. In the case of using an electron beam curable resin as the binder resin material of the lower non-magnetic layer, the lower non-magnetic layer is irradiated with an electron beam, so as to be cured. Next, a coating material for the magnetic layer is applied onto the cured lower non-magnetic layer, oriented and dried to form the upper magnetic layer. The timing when the back coat layer is formed may be selected at will. Specifically, the back coat layer may be formed before the formation of the lower non-magnetic layer, after the formation of the lower non-magnetic layer and before that of the upper magnetic layer, or after the formation of the upper magnetic layer.

The method used for applying the above-mentioned coating materials may be any one selected from known various coating methods such as gravure coating, reverse roll coating, die nozzle coating, and bar coating.

### EXAMPLES

The present invention will be more specifically described by way of the following examples; however, the present invention is not limited to the examples.

### [Method for Measuring Powder Property]

### (Measurement of the Average Major Axis Length)

A powder to be measured was photographed with a transmission electron microscope (TEM) with a magnification of 100,000. About 100 particle-images drawn at random from the photograph, the major axis lengths were measured. The average of these values was defined as the average major axis length.

### (Measurement of the Specific Surface Area Based on the BET Method)

A BET measuring device (one out of NOVA 2000 series, manufactured by Quantachrome Instruments) was used to measure the specific surface area by the BET method. More specifically, the measurement was made as follows:

A cell was dried in an oven 90° C. in temperature, and the dried cell was naturally cooled to 20° C. in an atmosphere 20° C. in temperature and 45% in relative humidity. Operations subsequent thereto would be carried out in an atmosphere 20° C. in temperature and 45% in relative humidity.

The weight (w₁) of the tare of the cell was measured. A powder sample to be measured was weighed off by about 0.2 to 0.3 g. The measurement sample was filled into the cell for measurement, and a filter for preventing powder from scattering away was inserted into an end portion of the cell. The cell was set to a mantle heater attached to the BET measuring device (NOVA 2000, manufactured by Quantachrome Instruments), and the cell was subjected to deaeration treatment at 150° C. for 1 hour. The cell was taken off, and then the filter was taken off. The weight (w₂) of the cell containing the powder sample was then measured in an atmosphere 20° C. in temperature and 45% in relative humidity. The weight (w) of the powder sample to be measured was calculated out (w=w₂−w₁).

The cell containing the powder sample was set to the BET measuring device, and a predetermined volume of liquid nitrogen was filled into an attached Dewar flask. A measuring program was started to make a measurement at a temperature of liquid nitrogen (77 K). After the end of the measurement, the powder sample was collected.

### (Measurement of the Amount of Moisture)

A moisture content automatically measuring device in a coulometric titration method mode manufactured by Mitsubishi Chemical Corp. was used, and the following products were used as an anode liquid reagent and a cathode liquid reagent, respectively: AQUA MICRON AX, and AQUA MICRON CXU.

After the sense of the measuring device was stabilized, about 600 mg of a checking solution was charged into the electrolytic cell before a measurement in order to confirm the normality of the electrodes. It was confirmed that, a normal measured value for the checking solution was observed.

Devices CA-100 model and VA-100 model were used to set measuring parameters as follows:

Delay: 1 min., Min Titr: 2 min., Titr Stop: 0 min., End Sense: 0.1 μg/sec., Print Form: 3, Calc Form: 1, Calc Unit: 0, VAS elect: 1, VA Temp: 100° C. (designated temperature), Purge: 1 min., Preheat: 2 min., and Cooling: 2 min.

A sample (g) was charged thereto in an amount corresponding to an anticipated amount of moisture. The amount of moisture was measured 5 times. The average of the three values other than the maximum value and the minimum value was defined as the total extracted moisture value (g).

The amount of moisture per unit weight of the powder was calculated in accordance with the following equation:

Amount of moisture(% by weight)per unit weight=[Total extracted moisture value(g)/Sample weight(g)]×100

After the above measurement, it was confirmed that an observed value for the checking solution was the same value as before the measurement.

The amount of moisture (mg/m²) per unit specific surface area of the powder was calculated from the BET specific surface area value (m²/g) and the amount of moisture (% by weight) per unit weight.

### Preparation Example of Iron Oxide

Iron oxide used in Example 1 was prepared as follows:

To a 0.5 mol/L aqueous solution of Fe³⁺ was added an aqueous solution of sodium hydroxide in an amount of 1.3 equivalents relative to the amount of Fe³⁺ while the former solution was stirred and the temperature of the solution was kept at 10° C. In this way, a precipitation of ferric hydroxide was produced. Thereafter, the suspension containing this precipitation was kept at a temperature of 30° C. so as to be matured for 10 hours, thereby adjusting the major axis length and producing iron hydroxide oxide α-FeOOH. Next, to this suspension containing α-FeOOH was added an aqueous solution of phosphoric acid to set the amount of P to 2.0% by weight of α-FeOOH while the suspension was stirred. In this way, P was deposited on α-FeOOH. Thereafter, thereto was further added an aqueous solution of yttrium to set the percentage by atom of Y to Fe (Y/Fe) in α-FeOOH to 1.0% by atom while the suspension was stirred. The pH was set to 9 or less to deposit Y on α-FeOOH. The suspension of α-FeOOH, on which P and Y were deposited, was filtrated, and the residue was washed with water and dried. The resultant powder α-FeOOH was subjected to calcination treatment at 650° C. in the atmosphere for 60 minutes to yield a powder of α-Fe₂O₃.

Furthermore, the resultant α-Fe₂O₃ powder was kept in nitrogen gas flow, 60° C. in temperature, containing 2% by volume of water vapor for 30 minutes to yield a desired α-Fe₂O₃ powder (I) having an amount of moisture per specific surface area of 0.13 mg/m².

In Table 1 are shown powder property of the resultant α-Fe₂O₃ powder (I) [the average major axis length (nm), the BET specific surface area (m²/g), the amount of moisture per unit weight (% by weight), and the amount of moisture per unit specific surface area (mg/m²)]; and individual conditions in the preparation step [the maintenance temperature (° C.) of the suspension of ferric hydroxide, the ratio (% by atom) of Y/Fe in α-FeOOH, and the concentration (% by volume) of water vapor contained in the nitrogen gas flow]. This iron oxide (I) was used in Example 1.

The conditions in the preparation step [the maintenance temperature (° C.) of the suspension of ferric hydroxide, the ratio (% by atom) of Y/Fe in α-FeOOH, and the concentration (% by volume) of water vapor contained in the nitrogen gas flow] were changed as shown in Tables 1 to 3 to yield α-Fe₂O₃ powders having various powder property [average major axis length (nm), BET specific surface area (m²/g), amount of moisture per unit weight (% by weight), and amount of moisture per unit specific surface area (mg/m²)]. The resultant iron oxide powders were used in Examples 2 to 20 and Comparative Examples 1 to 28, respectively.

### Example 1

(Preparation of a non-magnetic layer coating material)

| | |
|---|---|
| Iron oxide (I) | 80.0 parts by mass |
| Carbon black | 20.0 parts by mass |
| (trade name: # 950B, manufactured by Mitsubishi Chemical Corp., | |
| average particle diameter: 17 nm, BET specific surface area: | |
| 250 m²/g, DBP oil absorption: 70 mL/100 g, pH: 8) | |
| Electron beam curable binder: electron beam curable vinyl | 12.0 parts by mass |
| chloride resin | |
| (trade name: TB-0246, manufactured by Toyobo Co., Ltd.) | |
| Electron beam curable binder: electron beam curable polyurethane | 10.0 parts by mass |
| resin | |
| (trade name: TB-0216, manufactured by Toyobo Co., Ltd.) | |
| Dispersant: phosphoric acid surfactant | 3.2 parts by mass |
| (trade name: RE-610, manufactured by Toho Chemical Industry Co., | |
| Ltd.) | |
| Abrasive: α-alumina | 5.0 parts by mass |
| (trade name: HIT60A, manufactured by Sumitomo Chemical Co., Ltd., | |
| average particle diameter: 0.18 μm) | |
| NV (solid concentration) = 70% by mass | |
| Solvent ratio: MEK/toluene/cyclohexane = 2/2/1 (ratio by mass) | |

The above-mentioned materials were kneaded by a kneader. Thereafter, a solvent having the same blend ratio as described above was used to dilute the kneaded product to give an NV (solid concentration) of 33%. The solid components in this diluted product were dispersed for a retention time of 60 minutes by a lateral type pin mill into which zirconia beads having a diameter of 0.8 mm were filled at a filling ratio of 80% (percentage of voids:50% by volume). During the dispersion, the diluted product was sampled, and the viscosity was appropriately measured. The highest viscosity out of the measured viscosities is shown as “Dispersion viscosity (cp)” in Table 1.

Thereafter, the following lubricant materials were added thereto and diluted so as to give an NV (solid concentration) of 25% (percentage by mass) and a solvent ratio (MEK/toluene/cyclohexane) of 2/2/1 (ratio by mass):

| | |
|---|---|
| Lubricant: fatty acid (trade name: NAA180, | 0.5 part by mass |
| manufactured by NFO Corp.): | |
| Lubricant: fatty acid amide (trade name: FATTY | 0.5 part by mass |
| ACID AMIDE S, manufactured by Kao Corp.): | |
| Lubricant: fatty acid ester (trade name: | 1.0 part by mass |
| NIKKOLBS, manufactured by Nikko | |
| Chemicals Co., Ltd.): | |

Thereafter, the solid components therein were dispersed, and the dispersion was transferred to a tank. The viscosity of the coating material at the time of the transfer was measured. The viscosity was 100 cp.

The resultant coating material was allowed to stand still in the tank for 24 hours. The viscosity of the coating material after the standing for 24 hours was measured. The value of this viscosity is shown as “Viscosity (cp) after 24 hours” in Table 1.

Subsequently, the resultant coating material was further filtrated through a filter having an absolute filtration precision of 1.0 μm to produce a non-magnetic coating material of Example 1.

(Preparation of a magnetic layer coating material)

| | |
|---|---|
| Ferromagnetic powder: Fe acicular ferromagnetic powder | 100.0 parts by mass |
| (Fe/Co/Al/Y = 100/24/5/8 (ratio by atom), Hc: 188 kA/m, σs: 140 Am²/kg, | |
| BET specific surface area value: 50 m²/g, average major | |
| axis length: 0.10 μm) | |
| Thermosetting vinyl chloride resin: vinyl chloride copolymer | 10.0 parts by mass |
| (trade name: MR110, manufactured by Nippon Zeon Co., Ltd.) | |
| Thermosetting polyurethane resin: polyester polyurethane | 6.0 parts by mass |
| (trade name: UR8300, manufactured by Toyobo Co., Ltd.) | |
| Dispersant: phosphoric acid surfactant | 3.0 parts by mass |
| (trade name: RE610, manufactured by Toho Chemical Industry Co., | |
| Ltd.) | |
| Abrasive: α-alumina | 10.0 parts by mass |
| (trade name: HIT60A, manufactured by Sumitomo Chemical Co., Ltd., | |
| average particle diameter: 0.18 μm) | |
| NV (solid concentration) = 70% by mass | |
| Solvent ratio: MEK/toluene/cyclohexanone = 4/4/2 (ratio by mass) | |

The above-mentioned materials were kneaded by a kneader. Thereafter, a solvent having the same blend ratio as described above was used to dilute the kneaded product to give an NV (solid concentration) of 30%. For pre-dispersion of the solid components in this diluted product, the components were dispersed by a lateral type pin mill into which zirconia beads having a diameter of 0.8 mm were filled at a filling ratio of 80% (percentage of voids:50% by volume).

Thereafter, the pre-dispersed coating material was further diluted to give an NV (solid concentration) of 15% (percentage by mass) and a solvent ratio (MEK/toluene/cyclohexane) of 22.5/22.5/55 (ratio by mass). The resultant was then finish-dispersed. Subsequently, to the resultant coating material were added 4 parts by mass of a heat-hardener (trade name: COLONATE L, manufactured by Nippon Polyurethane Industry Co., Ltd.), and the components were mixed. Thereafter, the mixture was filtrated through a filter having an absolute filtration precision of 0.5 μm to produce a magnetic layer coating material.

(Preparation of a back coat layer coating material)

| | |
|---|---|
| Carbon black | 75.0 parts by mass |
| (trade name: BP-800, manufactured by Cabot Corp., average | |
| particle diameter: 17 nm, DBP oil absorption: 68 mL/100 g, BET | |
| specific surface area: 210 m²/g) | |
| Carbon black | 15.0 parts by mass |
| (trade name: BP-130, manufactured by Cabot Corp., average | |
| particle diameter: 75 nm, DBP oil absorption: 69 mL/100 g, BET | |
| specific surface area: 25 m²/g) | |
| Calcium carbonate | 10.0 parts by mass |
| (trade name: HAKUENKA 0, manufactured by Shiraishi Kogyo, average | |
| particle diameter: 30 nm) | |
| Nitrocellulose | 65.0 parts by mass |
| (trade name: BTH1/2, manufactured by Asahi Chemical Co., Ltd.) | |
| Polyurethane resin | 35.0 parts by mass |
| (aliphatic polyester diol/aromatic polyester diol = 43/57) | |
| NV (solid concentration) = 30% by mass | |
| Solvent ratio: MEK/toluene/cyclohexane = 1/1/1 (ratio by mass) | |

The above-mentioned materials from which some of the organic solvents were removed, which were in a high viscosity state, were sufficiently kneaded by a kneader. Next, the removed organic solvents were added to the kneaded materials, and the resultant was sufficiently stirred by a dissolver. The materials were then kneaded by a kneader. Thereafter, for pre-dispersion of the solid components in the kneaded product, the components were dispersed by a lateral type pin mill into which zirconia beads having a diameter of 0.8 mm were filled at a filling ratio of 80% (percentage of voids: 50% by volume).

Thereafter, the pre-dispersed material was further diluted to give an NV (solid concentration) of 10% (percentage by mass) and a solvent ratio (MEK/toluene/cyclohexane) of 50.0/40.0/10.0 (ratio by mass). The resultant was then finish-dispersed. Subsequently, to the resultant coating material were added 10 parts by mass of a heat-hardener (trade name: COLONATE L, manufactured by Nippon Polyurethane Industry Co., Ltd.), and the components were mixed. Thereafter, the mixture was further filtrated through a filter having an absolute filtration precision of 0.5 μm to produce a back coat layer coating material.

### (Step of Forming a Non-Magnetic Layer)

The non-magnetic layer coating material was applied onto one surface of a base film (polyethylene naphthalate film) 6.2 μm in thickness by extrusion coating method from a nozzle, so as to give a thickness of 2.0 μm after calendering described below. The applied layer was dried. Thereafter, a calender in which a plastic roll was combined with a metal roll was used to calender the resultant under the following conditions: the nip number: 4, working temperature: 100° C., and linear pressure: 3500 N/cm. Furthermore, electron beams were radiated thereto at an irradiation dose of 4.0 Mrad and an accelerating voltage of 200 kV to form a lower non-magnetic layer.

### (Step of Forming a Magnetic Layer)

The magnetic layer coating material was applied onto the lower non-magnetic layer formed as described above by extrusion coating method from a nozzle, so as to give a thickness of 0.2 μm after calendering described below. The resultant was oriented and dried. Thereafter, a calender in which a plastic roll was combined with a metal roll was used to calender the resultant under the following conditions: the nip number: 4, working temperature: 100° C., and linear pressure: 3500 N/cm. In this way, an upper magnetic layer was formed.

### (Step of Forming a Back Coat Layer)

The back coat layer coating material was applied onto the other surface of the base film by extrusion coating method from a nozzle, so as to give a thickness of 0.7 μm after calendering described below. The resultant was then dried. Thereafter, a calender in which a plastic roll was combined with a metal roll was used to calender the resultant under the following conditions: the nip number: 4, working temperature: 100° C., and linear pressure: 3500 N/cm. In this way, a back coat layer was formed.

The magnetic recording tape web yielded as described above was thermally set at 60° C. for 48 hours. Next, the tape web was slit into a width of ½ inch (=12.650 mm) to form a tape for data as a magnetic recording tape sample of Example 1.

### Examples 2 to 12, and Comparative Examples 1 to 28

Non-magnetic layer coating materials were prepared in the same way as in Example 1 except that 80 parts by mass of respective iron oxides shown in Tables 1 to 3 were used in the preparation of the coating material instead of 80 parts by mass of the iron oxide (I) used in Example 1. In the preparation of each of the non-magnetic layer coating materials, the suspension was diluted to give an NV (solid concentration) of 25% by mass, and subsequently the viscosity of the coating material was measured when the coating material was transferred to the tank. As a result, the viscosity was about 100 cp. The resultant individual non-magnetic layer coating materials were used to form magnetic recording tape samples, respectively, in the same way as in Example 1.

### [Evaluation of the Magnetic Tapes]

Each of the magnetic recording tape samples was evaluated as follows:

(Surface roughness (centerline average roughness: Ra))

A system (trade name: TALYSTEP SYSTEM, manufactured by Taylor Hobson Co.) was used to measure the centerline average roughness Ra of the magnetic layer surface of the tape in accordance with JIS B0601-1982.

Conditions for the measurement were as follows: filter wavelength: 0.18 to 9 Hz, probe: 0.1×2.5 μm stylus, probe pressure: 2 mg, measuring velocity: 0.03 mm/sec., and measurement length: 500 μm. The measurement of the roughness Ra of the magnetic layer surface was made after the final calendering treatment and curing treatment.

(Measurement of the Bit Error Rate (b-ERT))

About each of the magnetic tape samples set into a cartridge, signals were recorded by mean of a magnetic recording head using a single recording wavelength of 0.25 μm as a recording wavelength. Signals having a P-P value (amplitude) of 50% or less of the P-P value (amplitude) of the above-mentioned signals were defined as missing pulses. Four or more continuous missing pulses were detected as a long defect. The number of long defects per meter of the magnetic tape sample of Example 18, as a reference tape, was represented by N, and the number of long defects per meter of each of the magnetic tape samples was represented by X. About each of the magnetic tape samples, the log₁₀(X/N) was calculated as the bit error rate thereof. The calculated individual bit error rates were compared. The used reproducing head was a magneto resistive magnetic head (MR head).

The results from the above-mentioned measurements are shown in Tables 1 to 3.

As is evident from Table 1, in each of Examples 1 to 20, the rising ratio of the viscosity after the standing for 24 hours to the viscosity (=about 100 cp) at time of the transfer of the coating material to the tank was small; thus, the non-magnetic layer coating material was stable. In other words, in spite of the use of the fine iron oxide powder having an average major axis length of 30 to 100 nm and a specific surface area, based on the BET method, of 80 to 120 m²/g, the iron oxide contained moisture in an amount per specific surface area of 0.13 to 0.25 mg/m²; therefore, the dispersibility was good and the stability of the non-magnetic layer coating material was attained. Since these non-magnetic layer coating materials were used, the lower non-magnetic layers exhibited good surface smoothness. Thus, about all of the magnetic tape samples of Examples 1 to 20, their upper magnetic layers realized good surface smoothness and excellent electromagnetic conversion property.

On the other hand, about the magnetic tape samples of Comparative Examples 1 to 28, their upper magnetic layers were poor in surface smoothness and electromagnetic conversion property.

In Comparative Examples 5 to 8 and Comparative Examples 25 to 28, the average major axis length of the iron oxides was 150 nm, and the iron oxide powders were coarse. When these coarse iron oxide powders were used, the dispersibility was good regardless of the amount of the contained moisture, and stable non-magnetic layer coating materials were obtained. However, the use of the coarse iron oxide powders made the surface roughness of the lower non-magnetic layers poor. Thus, about all of these magnetic tape samples, the surface smoothness of their upper magnetic layers was poor and the electromagnetic conversion property thereof was also poor.

TABLE 1

| | | | | | | | | | | Magnetic recording | |
|---|---|---|---|---|---|---|---|---|---|---|---|
| | Iron oxide powder | | | | | | | | | medium | |
| | | | | Amount of | | | | | | Surface | |
| | | | | moisture | | | | Non-magnetic layer | | roughness | |
| | Average | | Amount of | per unit | Maintenance | | | coating material | | Ra of | |
| | major | | moisture | specific | temperature | | | | Viscosity | magnetic | |
| | axis | BET | per unit | surface | of | Y/Fe | Concentration | Dispersion | after 24 | layer | |
| | length | [m²/ | weight | area | suspension | [at | of water vapor | viscosity | hours | Ra | |
| | [nm] | g] | [wt %] | [mg/m²] | [° C.] | %] | [Vol %] | [cp] | [cp] | [nm] | b-ERT |
| Example 1 | 30 | 80 | 1.04 | 0.13 | 30 | 1.0 | 2.0 | 3,000 | 130 | 1.8 | −1.20 |
| Example 2 | 30 | 85 | 2.13 | 0.25 | 30 | 1.5 | 4.0 | 2,000 | 120 | 1.7 | −1.30 |
| Example 3 | 30 | 120 | 1.56 | 0.13 | 30 | 10.0 | 3.0 | 4,000 | 140 | 2.0 | −1.00 |
| Example 4 | 30 | 120 | 2.10 | 0.18 | 30 | 10.0 | 3.5 | 3,500 | 135 | 1.9 | −1.10 |
| Example 5 | 30 | 120 | 3.00 | 0.25 | 30 | 10.0 | 6.0 | 3,000 | 130 | 1.8 | −1.20 |
| Example 6 | 45 | 80 | 1.04 | 0.13 | 35 | 1.0 | 2.0 | 3,000 | 130 | 2.0 | −1.00 |
| Example 7 | 45 | 85 | 2.13 | 0.25 | 35 | 1.5 | 4.0 | 2,000 | 120 | 1.9 | −1.10 |
| Example 8 | 45 | 120 | 1.56 | 0.13 | 35 | 10.0 | 3.0 | 4,000 | 140 | 2.2 | −0.80 |
| Example 9 | 45 | 120 | 2.10 | 0.18 | 35 | 10.0 | 3.5 | 3,500 | 135 | 2.1 | −0.90 |
| Example 10 | 45 | 120 | 3.00 | 0.25 | 35 | 10.0 | 6.0 | 3,000 | 130 | 2.0 | −1.00 |
| Example 11 | 65 | 85 | 1.11 | 0.13 | 40 | 1.5 | 2.0 | 3,000 | 130 | 2.3 | −0.70 |
| Example 12 | 65 | 85 | 2.13 | 0.25 | 40 | 1.5 | 4.0 | 2,000 | 120 | 2.2 | −0.80 |
| Example 13 | 65 | 120 | 1.56 | 0.13 | 40 | 10.0 | 3.0 | 4,000 | 140 | 2.5 | −0.50 |
| Example 14 | 65 | 120 | 2.10 | 0.18 | 40 | 10.0 | 3.5 | 3,500 | 135 | 2.4 | −0.60 |
| Example 15 | 65 | 120 | 3.00 | 0.25 | 40 | 10.0 | 6.0 | 3,000 | 130 | 2.3 | −0.70 |
| Example 16 | 100 | 80 | 1.04 | 0.13 | 50 | 1.0 | 2.0 | 3,000 | 130 | 2.8 | −0.20 |
| Example 17 | 100 | 85 | 2.13 | 0.25 | 50 | 1.5 | 4.0 | 2,000 | 120 | 2.7 | −0.30 |
| Example 18 | 100 | 120 | 1.56 | 0.13 | 50 | 10.0 | 3.0 | 4,000 | 140 | 3.0 | ±0.00 |
| Example 19 | 100 | 120 | 2.10 | 0.18 | 50 | 10.0 | 3.5 | 3,500 | 135 | 2.9 | −0.10 |
| Example 20 | 100 | 120 | 3.00 | 0.25 | 50 | 10.0 | 6.0 | 3,000 | 130 | 2.8 | −0.20 |

TABLE 2

| | | | | | | | | | | Magnetic recording | |
|---|---|---|---|---|---|---|---|---|---|---|---|
| | Iron oxide powder | | | | | | | | | medium | |
| | | | | Amount of | | | | | | Surface | |
| | | | | moisture | | | | Non-magnetic layer | | roughness | |
| | Average | | Amount of | per unit | Maintenance | | | coating material | | Ra of | |
| | major | | moisture | specific | temperature | | | | Viscosity | magnetic | |
| | axis | BET | per unit | surface | of | Y/Fe | Concentration | Dispersion | after 24 | layer | |
| | length | [m²/ | weight | area | suspension | [at | of water vapor | viscosity | hours | Ra | |
| | [nm] | g] | [wt %] | [mg/m²] | [° C.] | %] | [Vol %] | [cp] | [cp] | [nm] | b-ERT |
| Comparative | 20 | 80 | 1.04 | 0.13 | 20 | 1.0 | 2.0 | 21,000 | 2,100 | 5.1 | +2.10 |
| Example 1 | | | | | | | | | | | |
| Comparative | 20 | 80 | 2.00 | 0.25 | 20 | 1.0 | 4.0 | 19,000 | 1,900 | 4.9 | +1.90 |
| Example 2 | | | | | | | | | | | |
| Comparative | 20 | 120 | 1.56 | 0.13 | 20 | 10.0 | 3.0 | 20,000 | 2,000 | 5.0 | +2.00 |
| Example 3 | | | | | | | | | | | |
| Comparative | 20 | 120 | 3.00 | 0.25 | 20 | 10.0 | 6.0 | 18,000 | 1,900 | 4.8 | +1.80 |
| Example 4 | | | | | | | | | | | |
| Comparative | 150 | 80 | 1.04 | 0.13 | 60 | 1.0 | 2.0 | 3,000 | 130 | 5.1 | +2.10 |
| Example 5 | | | | | | | | | | | |
| Comparative | 150 | 80 | 2.00 | 0.25 | 60 | 1.0 | 4.0 | 2,000 | 120 | 4.9 | +1.90 |
| Example 6 | | | | | | | | | | | |
| Comparative | 150 | 120 | 1.56 | 0.13 | 60 | 10.0 | 3.0 | 4,000 | 140 | 5.0 | +2.00 |
| Example 7 | | | | | | | | | | | |
| Comparative | 150 | 120 | 3.00 | 0.25 | 60 | 10.0 | 6.0 | 3,000 | 130 | 4.8 | +1.80 |
| Example 8 | | | | | | | | | | | |
| Comparative | 30 | 70 | 0.91 | 0.13 | 30 | 0.0 | 1.8 | 3,000 | 130 | 4.3 | +1.30 |
| Example 9 | | | | | | | | | | | |
| Comparative | 30 | 70 | 1.75 | 0.25 | 30 | 0.0 | 3.5 | 2,000 | 120 | 4.2 | +1.20 |
| Example 10 | | | | | | | | | | | |
| Comparative | 30 | 130 | 1.69 | 0.13 | 30 | 15.0 | 3.4 | 4,000 | 140 | 4.5 | +1.50 |
| Example 11 | | | | | | | | | | | |
| Comparative | 30 | 130 | 3.25 | 0.25 | 30 | 15.0 | 6.5 | 3,000 | 130 | 4.3 | +1.30 |
| Example 12 | | | | | | | | | | | |
| Comparative | 100 | 70 | 0.91 | 0.13 | 50 | 0.0 | 1.8 | 3,000 | 130 | 5.1 | +2.00 |
| Example 13 | | | | | | | | | | | |
| Comparative | 100 | 70 | 1.75 | 0.25 | 50 | 0.0 | 3.5 | 2,000 | 120 | 4.9 | +1.80 |
| Example 14 | | | | | | | | | | | |
| Comparative | 100 | 130 | 1.69 | 0.13 | 50 | 15.0 | 3.4 | 4,000 | 140 | 5.0 | +2.10 |
| Example 15 | | | | | | | | | | | |
| Comparative | 100 | 130 | 3.25 | 0.25 | 50 | 15.0 | 6.5 | 3,000 | 130 | 4.8 | +1.90 |
| Example 16 | | | | | | | | | | | |

TABLE 3

| | | | | | | | | | | Magnetic recording | |
|---|---|---|---|---|---|---|---|---|---|---|---|
| | Iron oxide powder | | | | | | | | | medium | |
| | | | | Amount of | | | | | | Surface | |
| | | | | moisture | | | | Non-magnetic layer | | roughness | |
| | Average | | Amount of | per unit | Maintenance | | | coating material | | Ra of | |
| | major | | moisture | specific | temperature | | | | Viscosity | magnetic | |
| | axis | BET | per unit | surface | of | Y/Fe | Concentration | Dispersion | after 24 | layer | |
| | length | [m²/ | weight | area | suspension | [at | of water vapor | viscosity | hours | Ra | |
| | [nm] | g] | [wt %] | [mg/m²] | [° C.] | %] | [Vol %] | [cp] | [cp] | [nm] | b-ERT |
| Comparative | 30 | 80 | 0.80 | 0.10 | 30 | 1.0 | 1.6 | 14,000 | 1,400 | 4.3 | +2.00 |
| Example 17 | | | | | | | | | | | |
| Comparative | 30 | 80 | 2.40 | 0.30 | 30 | 1.0 | 4.8 | 13,000 | 1,300 | 4.2 | +1.80 |
| Example 18 | | | | | | | | | | | |
| Comparative | 30 | 120 | 1.20 | 0.10 | 30 | 10.0 | 2.4 | 15,000 | 1,500 | 4.5 | +2.10 |
| Example 19 | | | | | | | | | | | |
| Comparative | 30 | 120 | 3.60 | 0.30 | 30 | 10.0 | 7.2 | 14,000 | 1,400 | 4.3 | +1.90 |
| Example 20 | | | | | | | | | | | |
| Comparative | 100 | 80 | 0.80 | 0.10 | 50 | 1.0 | 1.6 | 14,000 | 1,400 | 5.1 | +2.00 |
| Example 21 | | | | | | | | | | | |
| Comparative | 100 | 80 | 2.40 | 0.30 | 50 | 1.0 | 4.8 | 13,000 | 1,300 | 4.9 | +1.80 |
| Example 22 | | | | | | | | | | | |
| Comparative | 100 | 120 | 1.20 | 0.10 | 50 | 10.0 | 2.4 | 15,000 | 1,500 | 5.0 | +2.10 |
| Example 23 | | | | | | | | | | | |
| Comparative | 100 | 120 | 3.60 | 0.30 | 50 | 10.0 | 7.2 | 14,000 | 1,400 | 4.8 | +1.90 |
| Example 24 | | | | | | | | | | | |
| Comparative | 150 | 80 | 0.80 | 0.10 | 60 | 1.0 | 2.0 | 3,000 | 130 | 5.1 | +2.10 |
| Example 25 | | | | | | | | | | | |
| Comparative | 150 | 80 | 2.40 | 0.30 | 60 | 1.0 | 4.0 | 2,000 | 120 | 4.9 | +1.90 |
| Example 26 | | | | | | | | | | | |
| Comparative | 150 | 120 | 1.20 | 0.10 | 60 | 10.0 | 3.0 | 4,000 | 140 | 5.0 | +2.00 |
| Example 27 | | | | | | | | | | | |
| Comparative | 150 | 120 | 3.60 | 0.30 | 60 | 10.0 | 6.0 | 3,000 | 130 | 4.8 | +1.80 |
| Example 28 | | | | | | | | | | | |

What is claimed is:

1. A magnetic recording medium comprising at least a non-magnetic support, a lower non-magnetic layer on one surface of the non-magnetic support, and an upper magnetic layer on the lower non-magnetic layer,
wherein the upper magnetic layer contains at least a ferromagnetic powder, and a binder resin material, and
the lower non-magnetic layer contains at least carbon black, iron oxide, and a binder resin material, and the iron oxide has an average major axis length of 30 to 100 nm, and a specific surface area based on the BET method of 80 to 120 m²/g, and the iron oxide contains moisture in an amount per unit specific surface area of 0.13 to 0.25 mg/m².

2. The magnetic recording medium according to claim 1, wherein the binder resin material contained in the lower non-magnetic layer is a cured product of an electron beam curable resin.

3. A process for producing a magnetic recording medium comprising at least a non-magnetic support, a lower non-magnetic layer on one surface of the non-magnetic support, and an upper magnetic layer on the lower non-magnetic layer, the process comprising the steps of:
applying, onto one surface of a non-magnetic support, a non-magnetic layer coating material which contains at least carbon black, iron oxide, and a binder resin material, wherein the iron oxide has an average major axis length of 30 to 100 nm, and a specific surface area based on the BET method of 80 to 120 m²/g, and the iron oxide contains moisture in an amount per unit specific surface area of 0.13 to 0.25 mg/m², and drying and curing the resultant, thereby forming a lower non-magnetic layer; and
applying, onto the lower non-magnetic layer, a magnetic layer coating material which contains at least a ferromagnetic powder, and a binder resin material, and drying the resultant, thereby forming an upper magnetic layer.
